(19) United States
(12) Patent Application Publication
(10) Pub. No.: US 2023/0279913 A1
(43) Pub. Date: Sep. 7, 2023

(54) Disc brake arrangement having brake lining at in outer circumferential face of a brake disc

(71) Applicant: HL MANDO CORPORATION, Pyeongtaek (KR)

(72) Inventors: Hatem SHAHIN, Pfaffenhofen (DE); Lothar WAGNER, Simmern (DE); Kai BRAUN, Friedrichsdorf (DE)

(21) Appl. No.: 18/178,542

(22) Filed: Mar. 6, 2023

(30) Foreign Application Priority Data
Mar. 4, 2022 (DE) 102022202250.5

(51) Int. Cl. F16D 65/12; F16D 49/18

(52) U.S. Cl. CPC F16D 65/123; F16D 49/18; F16D 65/06

(57) ABSTRACT

The invention concerns a disc brake arrangement for a vehicle, the disc brake arrangement comprising: a brake disc that is rotatable about a rotational axis; and at least one brake pad, wherein the brake disc comprises a disc member and a brake lining at an outer circumferential face of the disc member and wherein the brake pad is displaceable relative to the brake lining, so as to contact the brake lining during braking for generating a brake force.

### CROSS-REFERENCE TO RELATED APPLICATION

This application is based on and claims priority under 35 U.S.C. § 119 to German Patent Application No. 102022202250.5, filed on Mar. 4, 2022 in the German Patent and Trade Mark Office, the disclosures of which are incorporated herein by reference.

### TECHNICAL FIELD

The invention concerns a disc brake arrangement for a vehicle, a wheel arrangement for a vehicle, a brake disc and a brake pad. The vehicle may in particular be a road vehicle, such as a car, truck or bus.

### BACKGROUND

Disc brakes are widely used as wheel brakes in road vehicles. They typically comprise a brake disc that is mechanically coupled to a wheel for a joint rotation therewith. A brake pad is, with respect to a rotational axis of the brake disc and the vehicle wheel, axially movable relative to the brake disc. For generating a brake force, the brake pad contacts the brake disc, thereby slowing down the brake disc's rotation and the rotation of the vehicle wheel.

Typically, the brake disc is clamped between two brake pads that are arranged at opposite side faces of the brake disc. The brake pads are carried by a brake caliper that axially spans across the brake disc.

An example of a respective disc brake can e.g. be found in DE 10 2013 001 300 B4.

While such a design of a disc brake is established and proven, there remains room for improvement. For example, existing disc brakes often show undesired levels of mechanical vibrations and/or noise generation, especially squeal noise. Also, they can generate an undesired level of brake dust emission into the surroundings. Further known drawbacks concern the following: a corrosion of the brake disc, in particular at its faces which are contacted by the brake pads; a tendency to cause non-symmetric pad wear; an axial expansion of a brake caliper housing under high pressure, e.g. causing an undesired brake pedal feel and/or vibrations; a conning of the brake disc due to unequal thermal loading of its opposite side faces; an excessive heating of a caliper piston and/or caliper housing; a high level of additional brake fluid absorption within a caliper cavity, in particular due to a deformation of the brake caliper under pressure; an increased weight of the overall brake system.

### SUMMARY

It is thus an object of the present invention to provide a disc brake design which helps to remedy at least some of these existing disadvantages.

This object is solved by the subject matter according to the independent claims. Advantageous embodiments are defined in the dependent claims and in this description.

Accordingly, a disc brake arrangement for a vehicle is suggested, in particular for a non-track bound vehicle, such as a road vehicle. The disc brake arrangement comprises: a brake disc that is rotatable about a rotational axis; and at least one brake pad, wherein the brake disc comprises a disc member and a brake lining at an outer circumferential face of the disc member. The brake pad is (in particular radially) displaceable relative to the brake lining, so as to contact the brake lining during braking for generating a brake force.

Terms used herein such as axial, radial and circumferential may refer to the rotational axis. A radial direction may extend at an angle to said rotational axis and in particular orthogonally thereto. An axial direction may extend along said rotational axis. A circumferential direction may extend about or around the rotational axis.

The disc member may be a single part member or a multi-part member. It may generally be flat and/or circular. It may comprise a hub, in particular a wheel hub or axle hub. The hub may be configured as an axially protruding portion, in particular a central axially protruding portion. Said axially protruding portion may protrude to only one side and/or in only one axial direction. In one example, the hub axially protrudes relative to a radially outer section (in particular a ring section) of the brake disc.

Alternatively, the disc member may be free of substantial axial protrusions or at least free of only one-sided or one-directional axial protrusions. For example, the disc member may be planar and/or may be substantially mirror symmetric with respect to a cross-sectional plane extending orthogonally to the rotation axis.

The disc member may be massive or may at least partially be hollow. Hollow portions may e.g. be defined by hollow spaces within the disc member or by channels or drillings within the disc member. This helps to reduce weight. Also, the hollow portions may be a design feature to improve thermal and/or mechanical characteristics of the disc member.

The brake lining may, at least initially, have a constant radial thickness. It may extend along at least part of the circumferential face of the disc member and e.g. comprise a number of brake lining segments that form ring segments along said circumferential face. Optionally, the brake lining forms a closed ring along the outer circumferential face the disc member. The brake lining may be correspondingly shaped to said outer circumferential face, e.g. by being similarly curved and/or arranged concentrically therewith. It may form at least part of an outermost surface of the brake disc and in particular may from the outer circumferential surface of said brake disc. Preferably, it can be contacted from outside of the brake disc e.g. by a radially outer brake pad.

The brake lining may be configured according to any known configurations in terms of materials and/or thickness and/or friction coefficient, but may be positioned differently compared to the prior art. For example, instead of being jointly movable with the brake pad, it may be jointly movable (e.g. rotatable) with the brake disc. It may thus be rotatable relative to and/or along the brake pad and/or the brake pad may be displaceable relative to the brake lining. The latter may include a relative displacement to reduce a radial distance between the brake pad and brake lining to zero (i.e. until contact).

In one example, the complete or at least more than half of the axial width of the circumferential face of the disc member is covered by the brake lining. This may help to ensure a large contact area between the brake lining and brake pad.

The brake lining may radially protrude with respect to the disc member. It may form a radially protruding material layer on top of or at an outside of the circumferential face of the disc member. According to one embodiment, the brake lining is at least partially received within a recess (e.g. formed as a circumferential groove) in the disc member to improve a mechanical coupling thereto. Generally, the brake lining may be glued to the brake disc and/or may be fixed thereto by means of mechanical fixing elements, such as screws or rivets. Optionally, the brake lining is removably attached to the disc member, e.g. by means of said mechanical fixing elements. This allows for replacing it when worn out, although the brake lining can optionally be dimensioned to have a long service life which might not require replacing it.

For example, the brake lining may be sized, e.g. in terms of thickness and/or volume, to cover a defined total operating life cycle of a given vehicle and based on an expected extent of brake activations. This life cycle may e.g. include 250.000 kilometers of driving distance or a ten years driving period. This may help to limit operating costs.

The brake lining may comprise one or more slots. These may extend axially or circumferentially, in particular in a ring-like manner. The slots may be formed as recesses within the brake lining and may e.g. extend radially inwards with respect to an outer (contact) surface of the brake lining. Apart from said slots, a surface of the brake lining may be closed and/or smooth.

The remaining outer faces of the disc member, such as side faces, may be free of in the brake lining and may not be contacted to generate brake forces.

The brake pad may be positioned opposite the brake lining, in particular radially opposite thereto. Further, at least not braking it may be positioned radially outside of the brake lining (and thus radially outside of the disc member and/or brake disc).

The brake pad may be configured to generate frictional forces when contacting the brake lining, thereby slowing down a rotation of the brake disc.

The disc brake arrangement may comprise at least one actuator for displacing the brake pad, e.g. a hydraulic or electric actuator. This actuator may be comprised by a brake caliper, or generally put, a brake pad carrier to which the brake pad is coupled. The brake pad carrier may be stationary within the vehicle. It may comprise a displaceable member, such as a piston, as well as a hydraulic chamber or electric motor acting on said displaceable member. The displaceable member may be coupled to the brake pad, thereby carrying it and being able to displace it in order to contact the brake disc.

The disclosed disc brake arrangement may provide a number of advantages. For example, the brake disc may thermally expand in a radial direction. This may improve brake performance, e.g. by avoiding or even reversing an undesired increase in brake pedal travel. On the other hand, given that no frictional forces may be generated at the side faces of the brake disc, an in particular uneven axial thermal expansion can be limited.

A main heat sink of the disc brake arrangement may be represented by the brake pad which can thus provide a new design parameter for achieving a desired thermal distribution. Further, this may help to prevent an increase in pedal travel during periods of frequent brake activation, e.g. due to the brake pad thermally expending radially inwards towards the brake lining. This may counteract potential increases in a radial distance between the brake pad and brake lining that could otherwise occur, e.g. due to less favourable thermal expansion and/or the formations of a hydraulic piston chamber (i.e. caliper cavity) under load. The brake pad may e.g. be configured of a material having a large heat capacity, such as a metallic material and in particular cast iron.

At the same time, a risk of drag torque may be reduced. This is because radial oscillations of the brake disc which could cause such drag torque can be significantly smaller than axial oscillations. In existing brake disc designs, the latter may lead to undesired contacts between the brake pad and brake disc, thus causing drag torque even when not activating the brake. Similarly, a risk of aerodynamic suction forces that in existing brake disc designs likewise causes drag torque can be significantly reduced when braking at a circumferential face of the brake disc.

Apart from reducing drag torque, the prevention of undesired contacts between the brake pad and brake disc when not braking may also help to limit low frequency noises, such as rattle, moan, groan or howl noises.

Further, arranging the brake lining at a circumferential face of the brake disc may allow for providing an overall large brake lining surface at a small radius of the brake disc. Thus, the size and weight of the brake disc can be reduced compared to prior art designs, while achieving a similar brake performance. Additionally or alternatively, the extent of local wear can be reduced because the frictional forces are distributed across a larger surface. Thus, service life of the brake lining and/or brake disc can be increased.

Also, it has been found that the disclosed positioning and/or increased area of the brake lining may help to improve vibration characteristics of the disc brake. Accordingly, it may limit the generation of undesired brake noises, in particular squeal noises. For example, with the presently disclosed brake disc the number of Eigenfrequencies (in particular in the frequency scale from 1000 Hz to 6000 Hz) and/or the number of out of plane modes of the brake disc may be reduced compared to existing designs.

Further, with the disclosed design, brake dust will be generated at the circumferential face of the brake disc. There, it can more easily be collected or shielded from the surroundings or guided away from the surroundings, e.g. by means of some of the below discussed embodiments.

According to an embodiment, the brake lining comprises a friction material, the friction material for example comprising friction fibers or friction particles (e.g. metallic particles) and a binder. Accordingly, the friction material may be or comprise a material composition with particles and/or fibers distributed in a (rigid) binder material.

Additionally or alternatively, at least a contact surface of the brake pad that is configured to contact the brake lining during braking is made from a material that is different from the material of the brake lining, e.g. that is not a friction material and/or not a brake lining material.

Optionally, at least the contact surface (or the complete brake shoe) comprises a material that is harder than a material of the brake lining. This reduces wear of the contact surface compared to the brake lining. Additionally or alternatively, a friction coefficient of the contact surface may be smaller than that of the friction material.

In one example, the brake pad is made of or comprises a metallic material and in particular cast iron. For example, the brake pad (or at least a portion thereof comprising the contact surface) may be a one-piece metal cast part. The cast iron material may be a spheroidal graphite iron material. The brake lining, to the contrary, may not be a metal cast part and/or may not be made of or comprise cast iron. By using a metallic material and in particular cast iron for the brake pad, a preferable thermal expansion characteristic can be achieved.

According to an embodiment, the disc member is made from or comprises a material that is different from a material of the brake lining and/or the brake pad. In particular, said material may be lighter than a material of the brake lining and/or the brake pad. This can help to reduce weight and in particular a rotating mass. Also, this may allow to provide suitable individual material selections for each of the disc member, the brake lining and/or the brake pad, e.g. with regard to any of weight, rigidity, hardness, friction coefficient or thermal expansion.

According to a further aspect, the brake lining forms at least a section of a ring that extends along the outer circumferential face of the disc member. For example, the brake lining may form a continuous or closed ring that extends along the complete outer circumferential face. Put differently, the brake lining may form a ring-shaped material layer. This increases the effective surface area of the brake lining and may allow for a reduction of thickness of the brake lining to increase an effective radius. Also, this may be beneficial in terms of production and/or replacement of the brake lining. It may also improve support by and fixation of the brake lining to the disc member.

In one example, the brake lining comprises a number of brake lining segments or, put differently, is a multi-piece assembly. The brake lining segments may be arranged or distributed in a ring-like manner along the outer circumferential surface. They may be arranged at circumferential distances from one another so that a non-continuous or, in other words, locally interrupted ring is formed.

Slots may be provided in the brake lining to control or, put differently, direct the spreading of dust flow in certain directions (e.g. away from the surroundings and towards a dust collecting surface of the vehicle, said surface comprising an adhesive material). These slots may be formed as local recesses in a continuous and in particular ring-shaped brake lining. Alternatively, they may be formed by gaps between adjacent brake lining segments.

In one example, the disc brake arrangement comprises a plurality of brake pads. Each brake pad may be mounted to an individual brake pad carrier and/or may be displaced by a individually associated actuator. The brake pads may be arranged at angular distances from one another, said angular distances being defined about the rotational axis. Differently put, the brake pads may be spaced apart along the circumference of the brake disc. In one example, the angular distance may be approximately 180°. If more than two brake pads are provided, the angular distances may be equal between each pair of adjacent brake pads. For example, each angular distance between two adjacent brake pads may amount to 360°/n with n being the number of brake pads.

By providing a respective plurality of brake pads, the brake disc can be clamped by and/or in between the brake pads, thereby limiting vibrations and a one-sided loading of the brake disc. Advantageously, the brake pads may thus act as counter-bearings for each other.

It may be provided that the brake pad is arranged at a radial distance to the brake disc when not braking. On the other hand, at least a part of the brake pad may axially overlap with the brake lining. Thus, the brake pad may only have to be moved along one movement axis, in particular a radial axis, to contact the brake lining. This simplifies the design of the disc brake arrangement.

According to one example, a diameter of the disc member is not larger than eight times and in particular not larger than four times an axial width of the brake lining. This provides a compact and thus lightweight disc brake arrangement. Providing such a limited diameter is made possible by, contrary to the prior art, not using the side faces of the disc member as contact areas for the brake pad (or at least not as exclusive contact areas). Thus, the size of said side faces can be selected independently of a size of the contact area of the brake pads. Also, the amount of heat generated at or within said side faces decreases with the disclosed solution. Therefore, the need for dissipating heat at or by said side faces decreases which makes it possible to decrease their surface area, e.g. by reducing the diameter.

In particular in order to limit the emission of brake dust into the surroundings, the brake pad or brake pad carrier may comprise a recess in which the brake lining is at least partially received (e.g. also when not braking) or receivable (e.g. at least when braking). For example, the recess may be configured as a circumferential slot or groove in which an outer rim portion of the brake disc can be inserted and thus received, said rim portion comprising the brake lining. A rotation of the brake disc relative to the brake pad or brake pad carrier may be unobstructed by the recess.

When provided in the brake pad, a portion of the recess facing the brake lining may act as a contact surface of the brake pad. Said portion may form a bottom face of the recess. Optional radially protruding side portions or edge portions of the recess may not contact the brake lining.

When the recess is provided in the brake pad carrier, the brake pad may also be arranged in the recess. It may be radially displaceable the relative to said recess during braking.

Edge portions of the recess may radially overlap with the brake disc. By arranging the brake lining in a respective recess, an emission of brake dust into the surroundings can be limited. For example, said brake dust may adhere to optional adhesive surfaces that may be provided at (inner) faces of the recess. Also, the recess may provide a noise absorbing function during braking.

According to one example, the brake pad or brake pad carrier comprises at least one radially protruding portion that is arranged (e.g. also when not braking) or arrangeable (e.g. at least when braking) adjacent an axially outer face of the brake disc. In particular, said radially protruding portion may radially overlap with the brake disc, e.g. permanently or at least during braking.

Accordingly, it may also be provided that the radially protruding portion is arranged adjacent said axial outer face and/or radially overlaps the brake disc when not braking. During braking and when provided at the brake pad, the extent of the overlap may be increased by radially pushing said brake pad and thus is protruding portion inwards, i.e. towards a centre of the brake disc.

An axial outer face of the brake disc may also be referred to as a side face. The brake disc may have two side faces that face in opposite axial directions and that are connected by the circumferential face of the disc member and/or of the overall brake disc.

The radially protruding portion may form a side or edge portion of the above discussed recess. It may provide similar advantages as explained above in connection with the recess, i.e. a reduction of noise and brake dust emissions.

In this context, the brake pad or brake pad carrier may comprise a first radially protruding portion and a second radially protruding portion which are arranged or arrangeable adjacent to different (e.g. opposite) axial outer faces of the brake disc during braking. Put differently, the brake disc may be arrangeable in a space between and/or may be axially surrounded by the first and second radially protruding portions. This provides a particularly efficient reduction of noise and dust emissions.

The invention also concerns a wheel arrangement for a vehicle, comprising a disc brake arrangement according to any of the aspects disclosed herein and a vehicle wheel that is at least indirectly coupled to the brake disc for a joint rotation therewith. The indirect coupling may e.g. be provided by not fixing the vehicle wheel directly to the disc brake (e.g. to a wheel hub comprised thereby), but to an axle component to which the disc brake is likewise coupled. The wheel may not be directly braked by the disc brake arrangement or any other breaking means. Instead, only the brake disc of the disc brake arrangement may be directly braked (i.e. contacted) as a result of which rotation of the vehicle wheel that is equally braked.

The invention also relates to a brake disc for a disc brake arrangement according to any of the examples disclosed herein, and in particular comprising a brake disc that is rotatable about a rotational axis and includes a disc member and a brake lining at an outer circumferential face of the disc member.

Further, the invention concerns a brake pad carrier for a disc brake arrangement according to any of the examples disclosed herein and in particular according to those examples comprising a recess and/or at least one radially protruding portion.

Specifically, a brake pad carrier is suggested for carrying a brake pad, the brake pad carrier comprising a recess and/or at least one radially protruding portion. In the recess, an outer circumferential face of a brake disc that it is to be braked by the brake pad may at least partially be receivable (e.g. at least during braking or permanently). The at least one radially protruding portion may be arrangeable adjacent to a side face of the brake disc (e.g. at least during braking or permanently).

The recess may comprise a bottom face which may in particular be curved, for example according to a curvature of a circumference of the brake disc. The recess may comprise edge portions extending in parallel to one another and/or in a circumferential direction. The edge portions may be spaced apart from and/or connected to one another by the bottom face. Accordingly, the recess may be a slot, in particular a curved slot. End faces of said slot and in particular opposite circumferential end faces may be open, so that an outer rim portion of the brake disc may rotate freely within said while partially being received therein and/or being partially surround thereby.

The protruding portions may be edge portions of a recess according to any of the examples disclosed herein.

Further disclosed is a brake pad for a disc brake arrangement according to any of the examples disclosed herein and in particular according to those examples comprising a recess and/or at least one radially protruding portion.

Specifically, the brake pad may comprise a recess and/or at least one radially protruding portion. In the recess, an outer circumferential face of a brake disc that it is to be braked by the brake pad may at least partially be receivable (e.g. at least during braking or permanently). The at least one radially protruding portion may be arrangeable adjacent to a side face of the brake disc (e.g. at least during braking or permanently).

The recess and protruding portion may be configured according to any of the examples disclosed here in particular in particular in connection with the brake pad carrier the above.

### BRIEF DESCRIPTION OF DRAWINGS

Embodiments of the invention are described in further detail below with respect to the attached schematic figures. Same features may be marked with the same reference signs throughout the figures.

FIG. 1 shows a disc brake arrangement according to a first embodiment.

FIG. 2 shows a disc brake arrangement according to a second embodiment.

FIG. 3 is a detail view of a brake pad of a disc brake arrangement according to a third embodiment.

FIGS. 4 to 7 illustrate possibilities for arranging one or a plurality of brake pads within disc brake arrangements according to further embodiments.

FIGS. 8-12 show modified versions of the embodiments of FIGS. 1-7.

### DETAILED DESCRIPTION

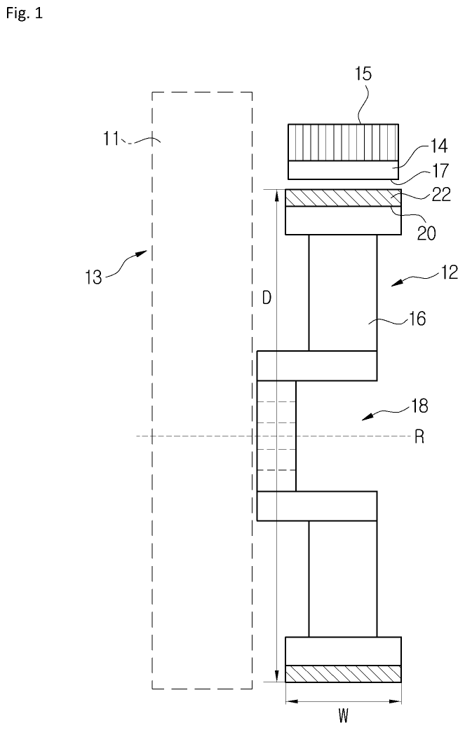

FIG. 1 shows a disc brake arrangement 10 according to a first embodiment. The disc brake arrangement 10 comprises a brake disc 12 and a brake pad 14, or in other words a brake shoe, arranged at a brake pad carrier 15, or in other words at a brake caliper.

The brake disc 12 comprises a single- or multi-part disc member 16 made from a metallic material. The disc member 16 is configured to rotate about a rotational axis R. In the example of FIG. 1, it comprises a central hub 18 that is configured as a wheel hub for mounting a schematically indicated vehicle wheel 11 of a vehicle wheel arrangement 13 thereto. The hub 18 forms a central axially protruding portion, which protrudes in only one axial direction (in FIG. 1 to the left).

An outer face of the brake disc 12 is formed by a brake lining 22. Said brake lining 22 is attached outer circumferential face 20 of the disc member 16. Only by way of example, an axial width W of said brake lining 22 covers the complete axial width of said circumferential face 20. The brake lining 22 is configured as a ring-shaped material layer running along the complete circumference of the brake disc 12.

The brake pad 14 is positioned radially outside of and, at least in the shown example, above the brake lining 22. Further, it axially overlaps with the brake lining 22. The brake pad 14 and more specifically a contact surface 17 thereof thus faces said brake lining 22 and can be brought into contact therewith for generating braking forces by a straight radial movement. The brake pad carrier to which the brake pad 14 is mounted comprises a non-depicted actuator, such as an electric motor or hydraulic piston, for generating said movement. The brake pad 14 is made from a metallic material and more specifically is a one-piece metal cast part.

FIG. 1 also indicates a diameter D of the brake disc 12. To provide a compact and lightweight brake disc arrangement 10, said diameter D may not amount to more than ten times and preferably not more than eight times or four times the axial width W.

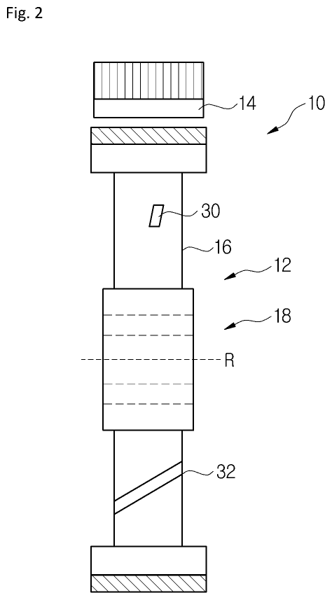

FIG. 2 shows a disc brake arrangement 10 according to a second embodiment. This disc brake arrangement 10 differs from the embodiment of FIG. 1 only with respect to the brake disc 12. Specifically, said brake disc 12 does not comprise an axially protruding wheel hub. Instead, the brake disc 12 forms a substantially planar member and comprises a hub 18 that is essentially arranged within a major plane of extension of the brake disc 12. The hub 18 is connectable to a non-depicted axle component of the vehicle. A non-depicted vehicle wheel that is to be braked by the disc brake arrangement 10 may equally be coupled to the same axle component and thus indirectly to the brake disc 12.

As further optional features that may be provided within any of the embodiments disclosed herein, hollow portions 30, 32 are depicted within the otherwise massive disc member 16 of the brake disc 12. The first portion 30 is configured as a hollow volume of arbitrary shape, e.g. cylindrical, rectangular or circular. A second hollow portion 32 is formed as a channel extending axially across and through the disc member 16. For example, said second hollow portion 32 may be a through-hole produced by drilling. The number of hollow portions 30, 32 can be larger than depicted and only one kind of first and second hollow portion 30, 32 may be provided. The hollow portions 30, 32 help to reduce weight.

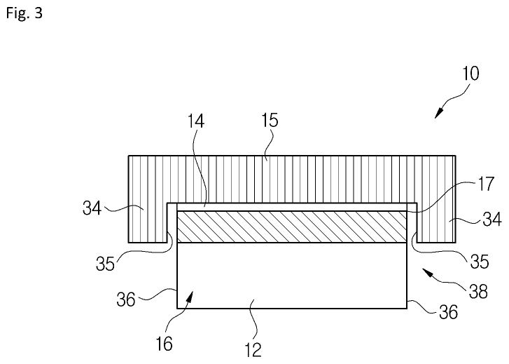

FIG. 3 shows a detail view of a disc brake arrangement 10 according to a third embodiment and specifically of a brake pad 14 and brake pad carrier 15 receiving a radially outer rim portion of an only partially depicted disc member 16 of said disc brake arrangement 10. The as such a stationary brake pad carrier 15 comprises radially inwards protruding portions 34 extending along and radially overlapping with both outer side faces 36 of the disc member 16. The protruding portions 34 thus represent edge portions of a recess 38 of the brake pad carrier 15 in which the outer rim portion of the disc member 16 and in a particular the brake lining 22. The recess 38 is generally shaped as a circumferential slot that is curved according to the curvature of the outer circumferential face of the brake disc 12. The contact surface 17 of the brake pad 14 is similarly curved. As an optional feature, the inner faces 35 of the protruding portions 34 may comprise an adhesive to collect brake dust emitted during braking.

In FIG. 3, the brake pad 14 contacts the brake lining 22 for generating braking forces. Note that FIG. 3 is only a schematic illustration that does not specifically indicate the radial displacement of the brake pad 14 relative to the stationary brake pad carrier 15 when the brake pad 14 contacts the brake lining 22.

In an alternative embodiment that is not specifically depicted, the radial protruding portions 34 are similarly arranged to the example of FIG. 3 but are provided at the movable brake pad 14. The rim portion of the brake disc 12 and in particular the brake lining 22 can again be received in between said protruding portions 34, e.g. within a recess or space confined by said protruding portions 34. The brake pad carrier 15 may in this case be free of respective protruding portions 34.

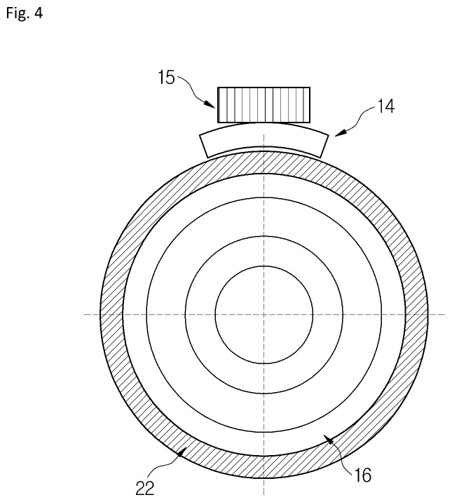

FIGS. 4 to 7 show various examples of distributing one or more brake pads 14 and respectively associated brake pad carriers 15 along the circumference of the brake disc 12. The examples of FIGS. 4-7 are non-limiting, i.e. different numbers and positions of brake pads 14 and brake pad carriers 15 may be provided.

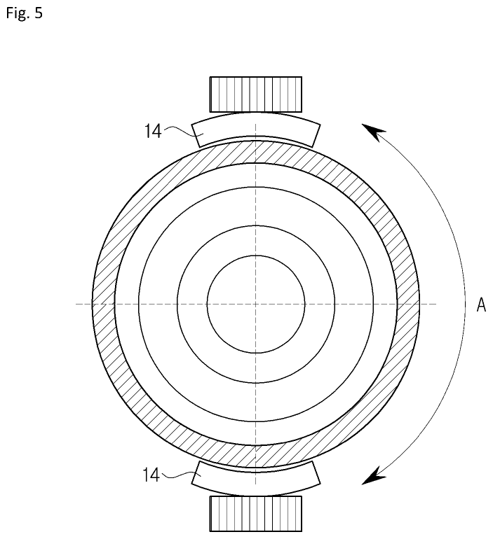

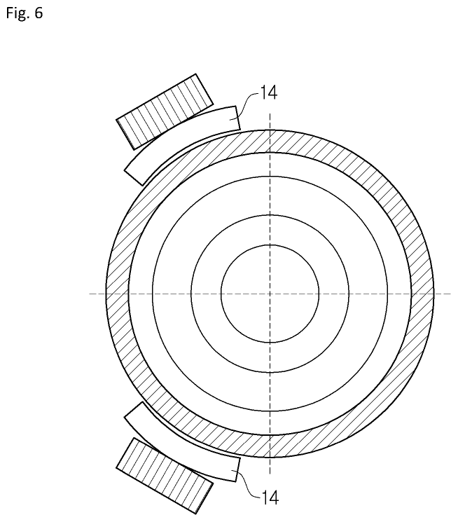

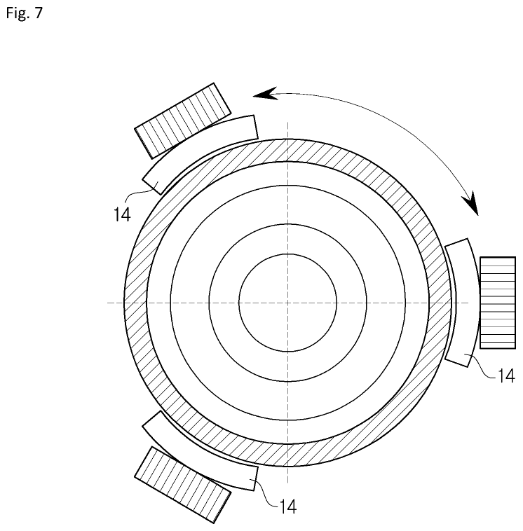

In case of FIG. 4, only one brake pad 14 is provided. In case of FIG. 5, two brake pads 14 are provided that are spaced apart an angle A of 180°. FIG. 6 indicates that a different spacing of two brake pads 14 is also possible. In FIG. 7, three brake pads 14 are provided which are spaced apart the equal angular distances A of 120°.

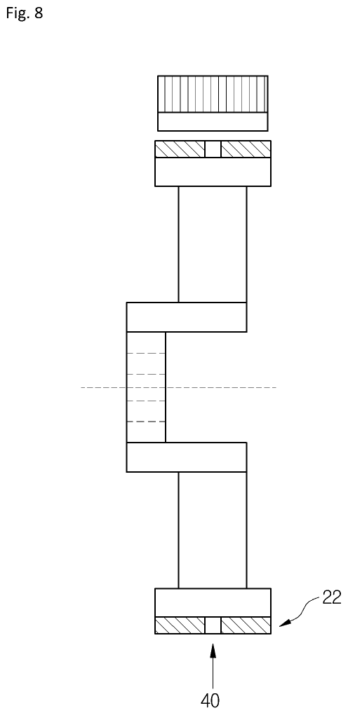

FIGS. 8-12 show modified versions of the embodiments of FIGS. 1-7. The modifications include providing slots 40 in the brake lining 22, said slots 40 being e.g. configured as grooves or recesses within the brake lining 22.

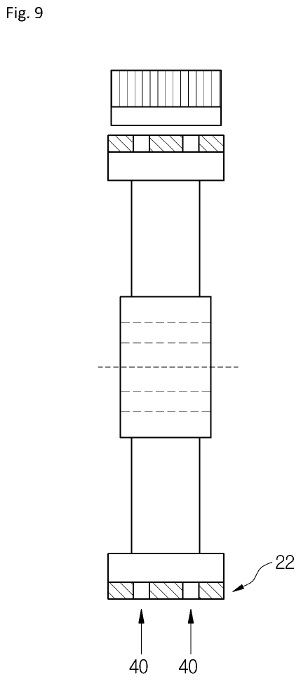

In FIGS. 8 and 9, which correspond to the embodiments of FIGS. 1 and 2, the slots 40 extend circumferentially and ring-like. They may form continuous rings or comprise a succession of circumferentially separated ring segments. In FIG. 9, two slots 40 are provided and are spaced apart along the rotational axis R. The number of slots 40 can be higher than depicted.

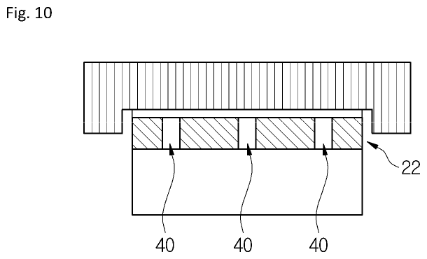

FIG. 10 corresponds to the embodiment of FIG. 3 and likewise shows an exemplary number of circumferential slots 40 that are axially spaced apart.

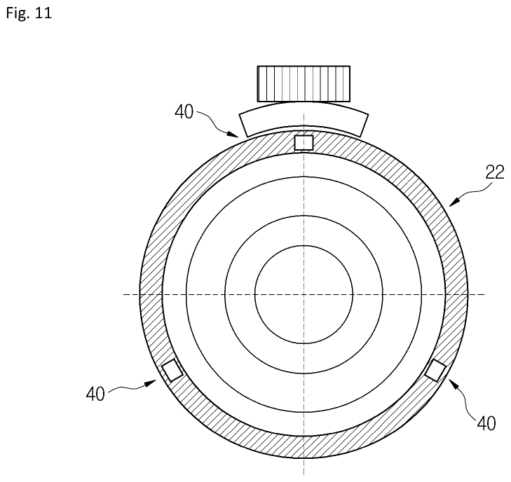

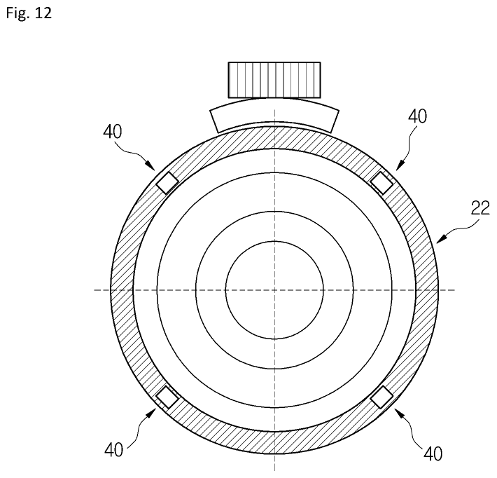

In FIGS. 11 and 12, the slots 40 extend axially instead of circumferentially. The number of slots 40 may be different from what is depicted in FIGS. 11 and 12.

It has been found that the slots 40 help to limit vibrations and emissions of noise when braking. Further, they may help to guide away water from the actual contact surfaces of the brake lining 22 to the brake pads 14. This may help to improve braking performance in wet conditions. Further, the slots 40 may improve the mechanical pressure distribution within the brake lining 22.

What is claimed is:

1. A disc brake arrangement for a vehicle, comprising:
a brake disc that is rotatable about a rotational axis; and
at least one brake pad,
wherein the brake disc comprises a disc member and a brake lining at an outer circumferential face of the disc member and wherein the brake pad is displaceable relative to the brake lining, so as to contact the brake lining during braking for generating a brake force.

2. The disc brake arrangement according to claim 1,
wherein the brake lining comprises a friction material.

3. The disc brake arrangement according to claim 1,
wherein at least a contact surface of the brake pad that is configured to contact the brake lining during braking is made from a material that is different from the material of the brake lining.

4. The disc brake arrangement according to claim 3,
wherein at least the contact surface of the brake pad comprises a material that is harder than a material of the brake lining.

5. The disc brake arrangement according to claim 1,
wherein the brake pad comprises a metallic material and in particular cast iron.

6. The disc brake arrangement according to claim 1,
wherein the disc member comprises a material that is different from a material of the brake lining.

7. The disc brake arrangement according to claim 1,
wherein the brake lining forms a preferably continuous ring extending along the outer circumferential face of the disc member.

8. The disc brake arrangement according to claim 1,
comprising a plurality of brake pads that are arranged at angular distances from one another about the rotational axis.

9. The disc brake arrangement according to claim 1,
wherein the brake pad is arranged at a radial distance to the brake disc when not braking.

10. The disc brake arrangement according to claim 1,
wherein a diameter of the disc member is not larger than eight times an axial width of the brake lining and in particular not larger than four times an axial width of the brake lining.

11. The disc brake arrangement according to claim 1,
wherein the brake pad or a brake pad carrier carrying the brake pad comprises a recess in which the brake lining is at least partially received or receivable.

12. The disc brake arrangement according to claim 1,
wherein the brake pad or a brake pad carrier carrying the brake pad comprises at least one radially protruding portion that is arranged or arrangeable adjacent a side face of the brake disc,
in particular wherein the brake pad of the brake pad carrier comprises a first radially protruding portion and a second radially protruding portion which are arranged or arrangeable adjacent different side faces of the brake disc.

13. A disc brake arrangement for a vehicle, comprising:
a brake pad carrier for a carrying a brake pad,
the brake pad carrier comprising at least one of:
a recess in which an outer circumferential face of a brake disc that it is to be braked by the brake pad is at least partially receivable; and
at least one radially protruding portion that is arrangeable adjacent to a side face of the brake disc.

14. A disc brake arrangement for a vehicle, comprising:
a brake pad for braking a brake disc,
the brake pad comprising at least one of:
a recess in which an outer circumferential face of the brake disc is at least partially receivable; and
at least one radially protruding portion that is arrangeable adjacent to side face of the brake disc.
